(19) United States
(12) Patent Application Publication
(10) Pub. No.: US 2004/0050770 A1
(43) Pub. Date: Mar. 18, 2004

(54) Device for separating a substance into two phases

(76) Inventor: Matheus Everardus Antonis, Rijkevoort (NL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/380,344

(22) PCT Filed: Sep. 13, 2001
(86) PCT No.: PCT/NL01/00677

(30) Foreign Application Priority Data
Sep. 15, 2000 (NL) 10161198

(51) Int. Cl. B01D 21/02

(52) U.S. Cl. 210/414

(57) ABSTRACT

The invention relates to a device (1) for separating a substance into two phases, which device (1) comprises a screw conveyor (5) including a shaft and at least one screw (5) which is mounted on said shaft, which screw conveyor extends between an intake opening (9) for the substance and an outlet opening (16) for one of said two phases, as well as a cylindrical screen (10) provided with screen openings (11), within the screw conveyor (5) is rotatably disposed for conveying the substance in a direction of transport from said intake opening (9) to said outlet opening (16) via flow surfaces lying in a radial plane between said shaft, two successive screw threads in said radial plane and the screen, and for discharging the other one of said two phases via said screen openings (11), wherein the screw length of the screw conveyor (5) is determined by the length of the screen within which the screw extends, and wherein the flow surface area increases along the entire screw lenth, seen in the direction of transport.

### DESCRIPTION

The invention relates to a device for separating a substance into two phases, which device comprises a screw conveyor including a shaft and at least one screw which is mounted on said shaft, which screw conveyor extends between an intake opening for the substance and an outlet opening for one of said two phases, as well as a cylindrical screen provided with screen openings, within which the screw conveyor is rotatably disposed for conveying the substance in a direction of transport from said intake opening to said outlet opening via flow surfaces lying in a radial plane between said shaft, two successive screw threads in said radial plane and the screen, and for discharging the other one of said two phases via said screen openings, wherein the screw length of the screw conveyor is determined by the length of the screen within which the screw extends. Within the framework of this invention, the term phases is to be understood to mean in particular fractions having different densities. To be perfectly clear, it is noted that the term flow surface only applies in those cases where the external diameter of the screw (substantially) abuts against the internal diameter of the screen. The term flow surface certainly does not apply in those cases where the external diameter gradually decreases to that of the shaft in a run-out portion of the screw at one end thereof, for example.

U.S. Pat. No. 4,069,980 discloses a device for separating meat from bones. A screw conveyor is rotatably disposed within the cylindrical screen, wherein the diameter of the screw body increases in the direction of transport whilst the pitch of the screw decreases in the direction of transport. As a result of this combination of characteristics, the flow surface area decreases in the direction of transport, by which measure it is attempted to compensate for the loss of material through the screen. Such a configuration of the screw conveyor involves the risk of the material to be separated getting wedged between the screw conveyor and the cylindrical screen. This risk increases as the viscosity of the material to be separated increases.

It is also known to fit such devices with adjustable shut-off means for the outlet opening, as disclosed in Dutch patent NL 1005398. Said shut-off means make it possible to build up a pressure between the screw conveyor and the screen, as a result of which a separation will take place through the screen, which is in particular important as the viscosity of the material separated by the screen increases. The drier the remaining fraction, the greater the risk of said fraction causing the device to jam.

A device of the kind referred to in the introduction is known from U.S. Pat. No. 3,273,495. Said invention relates to an oil expeller, wherein three pressure zones have been created within the screen. This is effected by initially enlarging the flow surface along the screw length, seen in the direction of transport, and subsequently reducing said flow surface by decreasing the screw pitch and increasing the shaft diameter. The consequence of this configuration is that the pressure in the final zone increases considerably, as a result of which the device is only suitable for processing a limited number of products, in view of the great risk of products getting wedged. More specifically, said device is not suitable for dewatering vegetables, plants, manure, paper, wood and textile, for example.

The object of the invention is to provide a solution for the above-described problems, and it is characterized in that the flow surface area increases along the entire screw length, seen in the direction of transport. As a result of this increase, free space is available for the substance between the screw conveyor and the screen, as a result of which even a very small increase of the flow surface area will already prevent the occurrence of blockage problems in practice.

This makes it possible to use relatively high (counter) pressures in the separation process, thus enhancing the efficiency of the separation process.

Advantageously, the screw conveyor terminates in a pressure chamber, in which the outlet opening is present. Said pressure chamber functions as a buffer, as it were, for building up pressure, as a result of which the pressure within the screen can remain within bounds. It should be realised thereby that such screens are usually very costly and vulnerable.

Preferably, the pressure chamber exhibits an increasing internal diameter, seen in the direction of transport, which reduces the risk of blockages of material in the pressure chamber and which renders the device suitable for various kinds of substances that are to be separated.

Preferably, the device according to the invention comprises adjustable shut-off means for the outlet opening. Said adjustable shut-off means make it possible to build up a specific pressure, in particular within the pressure chamber, in dependence on the nature of the substance to be separated. As a result of, the pressure buildup no longer depends on the friction between the substance to be separated on the one hand and the flanks of the screws and the wall of the screen on the other hand, but the pressure buildup is effected by the mechanical resistance that the adjustable shut-off means exert on the substance.

An increase of the flow surface can be obtained if the pitch of said at least one screw increases, the diameter of said shaft decreases and/or the diameter of said screen and said screw increases, all this in the direction of transport.

Advantageously, two screws arranged in the form of a double-threaded screw are mounted on the shaft, as a result of which the axial load on the screws remains within bounds. This advantage is in particular important when relatively high pressures are employed.

According to another preferred embodiment, the screw conveyor extends outside the screen on the side of the outlet opening. The advantage of this embodiment is that the conveying function of the screw conveyor is maintained beyond the screen, as a result of which in particular relatively dry fractions are prevented from getting wedged in the openings at the end of the screen. In addition, it is possible to build up pressure outside the screen by means of the part of the screw conveyor that extends outside the screen, as a result of which the mechanical load on the screen can be reduced.

Preferably, the screw conveyor extends outside the screen over a distance ranging between 0.05 m and 0.15 m. Within this range, a large number of substances can be efficiently separated into two phases by means of the device according to the invention. The risk of the material getting wedged within the screw conveyor is reduced by maintaining the lower limit, whilst the phase to be separated via the screen must flow back to the screen over too long a distance to enable separation thereof if the screw conveyor extends too far outside the screen.

Since the risk of jamming, in particular when a pressure chamber is used, is greatest within the area of the projecting length of the screw conveyor, the flow surface area of at least the part of the screw conveyor which extends outside the screen preferably increases in the direction of transport. In that case the flow surface is not bounded by the screen, of course, but by another surface being in line with the screen, for example the surface of a pressure chamber.

Preferably, in order to obtain a uniform separation process, the increase of the flow surface area is continuous at least along the screw length of the conveyor screw.

In particular for a specific type of substance, viz. the substance wherein solid particles are more or less suspended in a liquid, it is highly advantageous if a bypass opening is present in the part of the screen or the wall that surrounds the screw conveyor. If such a bypass opening is not used, there is a risk of suspended particles flowing back during the pressure buildup on the side of the screen that faces towards the outlet opening, as a result of which a cake will form within the screen, which may lead to a blockage within the screen. This risk is avoided by using the bypass opening, in that the suspended particles are discharged together with the liquid insofar as said particles have not been discharged via the screen yet. The material that passes the bypass opening can be returned to the intake opening of the device, for example. The shape of the opening may be circular, for example, which will appear to be the most practical shape, or square. The only thing that matters is that the dimensions of the opening are so large that suspended particles can freely flow through the bypass opening insofar as is necessary to prevent blockage problems. Another advantage of using the bypass opening is that it is possible to use higher (counter) pressures. The term counter pressure is understood to mean the pressure that prevails on the side of the screw conveyor that faces towards the outlet opening, for example in the pressure chamber.

Although the use of a bypass opening as described above can be readily combined with an increase of the flow surface area along the entire screw length, seen in the direction of transport, the advantages of the bypass opening will already become apparent when a flow surface area as employed in the prior art is used along the entire screw length, seen in the direction of transport, for example a constant flow surface area or a decreasing flow surface area. In that case a device for separating the substances into two phases is provided, therefore, which device comprises a screw conveyor including a shaft and at least one screw which is mounted on said shaft, which screw conveyor extends between an intake opening for the substance and an outlet opening for one of said two phases, as well as a cylindrical screen provided with screen openings, within which the screw conveyor is rotatably disposed for conveying the substance in a direction of transport from said intake opening to said outlet opening via flow surfaces lying in the radial plane between said shaft, two successive screw portions in said radial plane and the screen, and for discharging the other phase of said two phases via said screen openings, wherein a bypass opening is present in the part of the screen or the wall that surrounds the screw conveyor.

In order to optimize the efficiency of the screen, the bypass opening is preferably located on the side that faces towards the outlet opening, seen from halfway the length of the screen. It should be realised thereby that the material which passes the bypass opening is no longer subjected to the operation of the screen, or at least no longer directly so.

In order to further increase the efficiency of the screen, the bypass opening is preferably located in the cylindrical wall of the pressure chamber in the case wherein the screw conveyor extends outside the screen in said pressure chamber. An additional advantage is the fact that the pressure buildup will take place in particular in the area between the bypass opening and the discharge opening, as a result of which the load on the screen and the accompanying wear on the screen remain within bounds.

The bypass opening preferably has a diameter of at least 5 mm, more preferably at least 10 mm and even more preferably at least 20 mm. The optimum dimensions will partially depend on the dimensions and the shape of the screen openings, and also on the length of the screen, the pressure in the pressure chamber and the characteristics of the substance to be separated.

An advantageous position of the bypass opening is obtained when said bypass opening is located in a quadrant which extends perpendicularly to the central axis of the screw conveyor and whose axis of symmetry extends in horizontal direction, through the central axis of the screw conveyor. When the location of the bypass opening is selected in this manner, sediments that may be present at the bottom of the screw conveyor will not cause any inconvenience, whilst on the other hand a suitable fraction of the suspended particles can flow through the bypass opening insofar as necessary, in order to prevent blockage problems caused by suspended particles floating back.

The invention will now be explained in more detail with reference to the drawing, which shows a schematic longitudinal sectional view of a device according to the invention, wherein two neighbouring screw segments are partially broken away.

Separating device 1 comprises a housing 2, which is shown to be made in one piece, in actual practice, however, said housing will consist of a number of interconnected parts. Disposed within housing 2 is a screw conveyor 5, which can be rotated about axis 3 by means of driving unit 4, which screw conveyor substantially consists of a shaft 6, on which screws 7, 8 arranged in the form of a double-threaded screw are mounted, whose pitch increases in the direction of transport P2. An intake opening 9 is present in housing 2 for supplying the substance to be separated to the screw conveyor, as is schematically indicated by means of arrow P1. Rotation of screws 7, 8, will move the substance in the direction of transport P2. Screw conveyor 5 is surrounded by a cylindrical screen 10 along a central portion of its length, which screen is circumferentially provided with openings 11 for the passage of a first phase from the substance to be separated. Within the framework of the present invention, the length of the entire central portion of the length of the screw conveyor is indicated by the term screw length, since the screw extends along the entire length of the screw. It is also conceivable within the framework of the invention, however, that the screw extends over only the first 75% of the length of the screen, for example, as a result of which the screw length amounts to 75% of the length of the screen. In that case, however, the shaft may extend along the entire length of the screen and even beyond the screen, for example with a view to being mounted in bearings on either side. It will be understood that said screw length maximally equals the length of the screen.

Screens that can be used are for example disclosed in NL-C-1005938. The first phase lands in tubular chamber 12. Chamber 12 is provided with an outflow opening 13, via which opening the first phase can exit chamber 12, as is schematically indicated by arrow P3, for storage in reservoir 14 and/or for further processing. Screw conveyor 5 terminates in a cylindrical pressure chamber 15 positioned in line with screen 10, whose free end forms an outflow opening 16, which can be adjustably shut off by means of cone 17. The wall 20 of pressure chamber 15 exhibits a decreasing thickness, as a result of which pressure chamber 15 is slightly conical in shape. Cone 17 is present on the end of piston rod 18, which can be translated in the direction indicated by double arrow P4 through the action of single-action cylinder 19 in combination with the pressure that prevails in pressure chamber 15. Cylinder 19 is rigidly connected to framework 21, which is built up of a number of interconnected tubes and which is detachably connected to housing 2 to make it possible to carry out maintenance work on the device, in particular exchanging the screen 10. The material which passes the outflow opening 16 forms the second phase that remains after the first phase has been separated from the substance via screen 10. Said second phase is supplied to a reservoir 22 via outflow opening 27 in the wall of framework 21, as is schematically indicated by arrow P5.

In particular if the substance comprises a suspended phase, for example waste vegetables in water, the use of bypass opening 28 offers major advantages. Said bypass opening 28 is for example configured as a bore having a diameter of 25 mm, for example a bore which can be shut off. Bypass opening 28 is formed in the wall 20 of pressure chamber 15, and that in the part of said wall which still surrounds the screw conveyor 5, or more specifically screws 7, 8. Although bypass opening 28 is positioned at twelve o'clock in the figure for the sake of clarity, the bypass opening 28, several of which may be provided, of course, is preferably positioned at three o'clock or at nine o'clock, that is, at the vertical position of the central axis of screw conveyor 5.

The operation of the separating device 1 will now be explained in more detail. The substance to be separated is supplied to screw conveyor 5 via opening 9, as is indicated by arrow P1. Rotation of screw conveyor 5 will move the substance in the direction of transport P2, in principle until said substance passes the outflow opening 16, at which point the substance is in the form of a second phase. When the separation device 1 starts to operate, outflow opening 16 is completely shut off by means of cone 17. Only after the pressure in pressure chamber 15 has run up to a predetermined limiting value as a result of the continuous supply of substance, 1 cone 17 will be returned by the action of double-action cylinder 19, as a result of which an outflow opening is obtained. Depending on the nature of the substance and the dimension of the outflow opening 16, a dynamic equilibrium pressure will be generated within pressure chamber 15. As a result of said pressure, the first phase is separated via the openings 11 of screen 10. The pitch of the screws 7, 8 increases in the direction of transport P2. As a consequence of this, the flow surface. A as defined by the facing flanks 23, 24 of two successive screw threads and the intermediate part 25 of shaft 6 and the intermediate part 26 of screen 10, which lies in a radial plane, will likewise increase. As a result of this increase of the available space, the risk of blockages is considerably reduced.

If a bypass opening 28 is used and if the substance to be separated comprises a suspended phase, the occurrence of a return flow of the suspended phase in the direction of the screen during the pressure buildup to the adjusted limiting value in the pressure chamber 15 is prevented in that said part of the suspended phase, or at least part thereof, exits the pressure chamber 15 via bypass opening 28. Said part can subsequently be supplied to opening 9 again in the direction indicated by arrow P1.

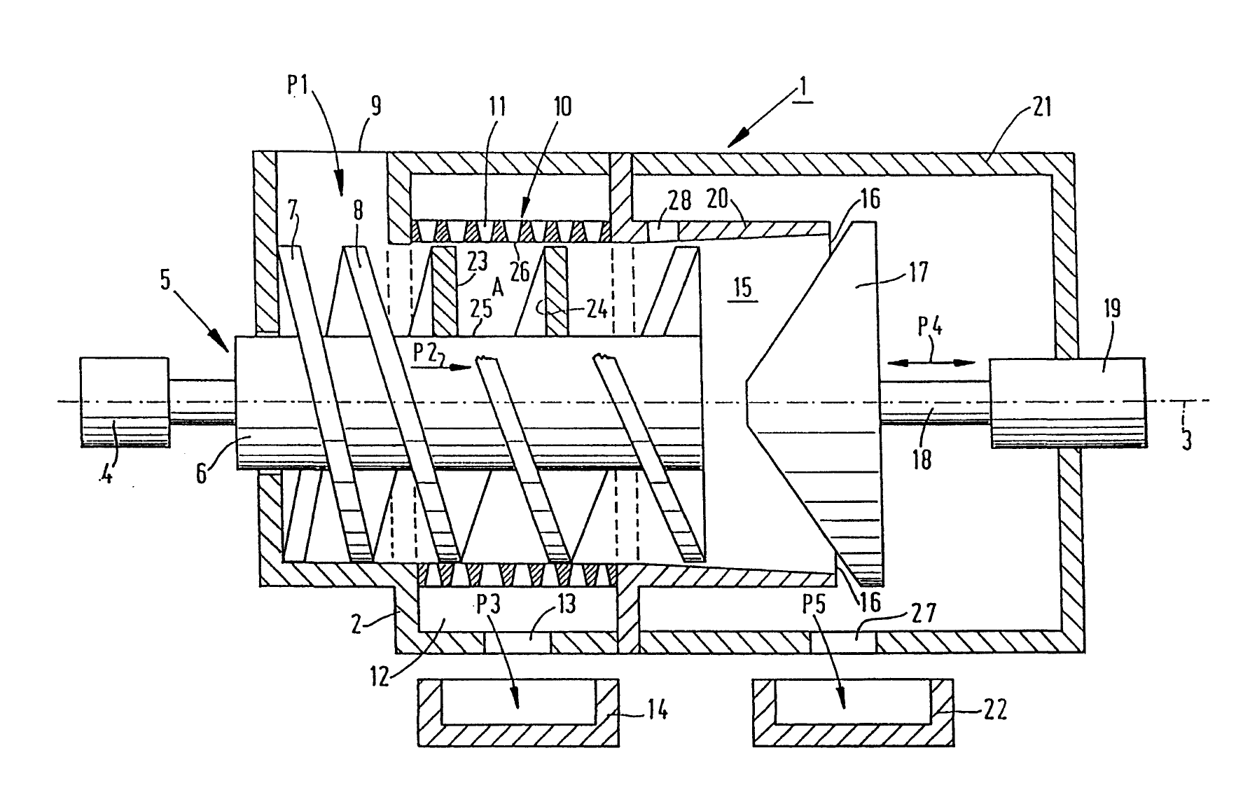

The above description of a device according to the invention is merely a schematic description. A device according to the prior art is disclosed in international patent application WO 98/37942, FIGS. 2, 3, and 4. Replacement of the single screw having a constant pitch that is used in said device by a single screw or multiple screws having a pitch which increases along the length of the screw conveyor, seen in the direction of transport, would result in a device according to the invention. Such a device is mentioned as a second possible embodiment herein.

The device according to the invention is suitable for use with various types of substances, such as manure, rinse water used in the canning industry, paper pulp, offal, food remnants and high-structure sludge, wherein relatively high counterpressures, for example of 10 bar, can be employed, as a result of which a high efficiency level can be obtained in spite of the fact that the risk of a substance getting wedged in the device is considerably decreased or even excluded altogether. The device is in particular suitable for substances that are separated into a solid phase and a liquid phase.

1. A device for separating a substance into two phases, which device comprises a screw conveyor including a shaft and at least one screw which is mounted on said shaft, which screw conveyor extends between an intake opening for the substance and an outlet opening for one of said two phases, as well as a cylindrical screen provided with screen openings, within which the screw conveyor is rotatably disposed for conveying the substance in a direction of transport from said intake opening to said outlet opening via flow surfaces lying in a radial plane between said shaft, two successive screw threads in said radial plane and the screen, and for discharging the other one of said two phases via said screen openings, wherein the screw length of the screw conveyor is determined by the length of the screen within which the screw extends, characterized in that the flow surface area increases along the entire screw length, seen in the direction of transport.

2. A device according to claim 1, characterized in that said screw conveyor terminates in a pressure chamber, in which the outlet opening is present.

3. A device according to claim 2, characterized in that the internal diameter of the pressure chamber increases in the direction of transport.

4. A device according to any one of the preceding claims, characterized in that adjustable shut-off means for the outlet opening are provided.

5. A device according to any one of the preceding claims, characterized in that the pitch of said at least one screw increases in the direction of transport.

6. A device according to any one of the preceding claims, characterized in that the diameter of the shaft increases in the direction of transport.

7. A device according to any one of the preceding claims, characterized in that the diameter of said screen and said screw increases in the direction of transport.

8. A device according to any one of the preceding claims, characterized in that two screws arranged in the form of a double-threaded screw are mounted on said shaft.

9. A device according to any one of the preceding claims, characterized in that the screw conveyor extends outside the screen on the side of the outlet opening, where it is surrounded by a cylindrical wall of a pressure chamber.

10. A device according to claim 9, characterized in that the screw conveyor extends outside the screen over a distance ranging between 0.05 m and 0.15 m.

11. A device according to claim 9 or 10, characterized in that the flow surface area of the part of the screw conveyor which extends outside the screen increases in the direction of transport.

12. A device according to any one of the preceding claims, characterized in that the increase of the flow surface area is continuous at least along the screw length of the conveyor screw.

13. A device according to any one of the preceding claims, characterized in that a bypass opening is present in the part of the screen or the wall that surrounds the screw conveyor.

14. A device according to claim 13, characterized in that said bypass opening is located on the side that faces towards the outlet opening, seen from halfway the length of the screen.

15. A device according to claims 9 and 14, characterized in that said bypass opening is formed in said cylindrical wall.

16. A device according to any one of the claims 13-15, characterized in that said bypass opening has a diameter of at least 5 mm, preferably at least 10 mm and more preferably at least 20 mm.

17. A device according to any one of the claims 13-16, characterized in that said bypass opening is located in a quadrant which extends perpendicularly to the central axis of the screw conveyor and whose axis of symmetry extends in horizontal direction, through the central axis of the screw conveyor.
